(19) United States
(12) Patent Application Publication
(10) Pub. No.: US 2010/0264713 A1
(43) Pub. Date: Oct. 21, 2010

(54) Seat back reclining member

(76) Inventor: Ming-Shiang Kang, Hsin Shih Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,818

(22) Filed: Apr. 21, 2009

(51) Int. Cl. B60N 2/20

(52) U.S. Cl. 297/364

(57) ABSTRACT

A reclining member of seat backs is revealed. The reclining member is arranged on center of a seat bracket. The reclining member includes locking slots on an adjustment rod and locating pin that lock with each other so as to make the seat back become a stable and positioned state after the reclining angle of the seat back being adjusted. Thereby users feel smooth and comfortable while reclining the seat back.

### BACKGROUND OF THE INVENTION

1. Fields of the Invention

The present invention relates to a seat back reclining member, especially to a reclining member of a seat back that adjusts the reclining angle of the seat back and provides a stable location so that users feel comfortable and stable while leaning on the seat back.

2. Descriptions of Related Art

Chairs are essentials for each family and are set in every corner such as a living room, a dining room or a bed room at home. Although each chair has different shapes and designs, they are all made for bringing people great comfortable feelings while sitting thereon.

Chairs with seat backs available now are divided into two types. One is a fixed type whose seat back is unable to recline. The other is adjustable type that reclines along with the back of people that sit on the chair. In the chair with a reclining function, the seat and the seat back is connected and integrated with each other into one part. Thus when people intend to recline the seat back, the seat also inclines relative to the seat back. Now the body's center of gravity shifts closer to the seat back and people lose their balance. Therefore, people feel uncomfortable or may even fall backward and get hurts.

An adjustment member that only inclines the seat back is invented in order to improve above shortcomings. A seat back reclining member is mounted incliningly between the bottom of the seat back and the rear side of the seat. The seat back reclining member is disposed with an elastic top brace member that provides the seat back an elastic support so that the seat back inclines along with the backward movement of users' bodies. However, such seat back reclining member replies on rigidity of the elastic top brace member and the reclining force from the users' back to the seat back. Thus people may feel uncomfortable once they recline their back because the seat back presses against their back and the operation of the reclining is unstable. Moreover, owing to repeated operation of reclining, elastic fatigue or even breaking easily occurs in the elastic top brace member. The seat back immediately loses the support and people sitting on the chair are injured.

Thus there is a need to provide a new design of the seat back reclining member that overcomes above disadvantages.

### SUMMARY OF THE INVENTION

Therefore it is a primary object of the present invention to provide a seat back reclining member that is adjusted easily and conveniently. Moreover, after being adjusted, the seat back is located stably so that people feel comfortable and steady to sit on.

In order to achieve above objects, a seat back reclining member of the present invention mainly assembled and connected with a seat bracket is composed of an adjustment unit, a brake lever and an operation rod.

The adjustment unit is disposed with two a sleeved sleeve. An adjustment rod with a plurality of locking slots (2121) thereon is mounted in the sleeves. Moreover, one end of the adjustment rod is an outer threaded section that is assembled with a threaded member connected on one end of the sleeve. A fixed connection part that connects with a seat back is formed on one end of the adjustment rod. An elastic member is also arranged in the sleeve. One end of the elastic member leans against the bottom of the sleeve while the other end of the elastic member is against and contacted with a blocking ring around the shaft sleeve that encloses the adjustment rod. An insertion hole is formed on the shaft sleeve while a pine bush is arranged above and connected with the insertion hole. A locating pin and a corresponding elastic member leaning against the locating pin are mounted in the pin bush. The bottom end of the locating pin inserts into the insertion hole of the shaft sleeve so as to lean against the locking slot of the adjustment rod while the top end of the locating pin projects out of the pin bush. Furthermore, a fixed connection part is formed on one end of the shaft sleeve so as to be assembled and connected with the seat bracket.

The brake lever is pivoted on an assembling disc of the seat bracket. A pressing block that extends from one side of the brake lever presses and brakes on the locating pin outside the pin bush while a stopper extends from the other side of the brake lever.

The operation rod consists of a main rod arranged in the assembling disc of the seat bracket, a stopping block connected with the main rod and corresponding to the bottom of the stopper of the brake lever, and a grip penetrating the assembling disc and extending from the main rod.

Thereby the seat back is located stably after the adjustment of the reclining angle by the locking and braking between the locking slot on the adjustment rod of the reclining member and the locating pin. Thus users feel smooth and comfortable while reclining the seat back.

The seat back reclining member of the present invention further includes stopping members disposed on two sides of the seat bracket and the seat back. By such design, the seat back is still got supported even the locating pin and the locking slot of the adjustment rod are not locked with each other firmly or the elastic member has become elastic fatigue or broken. Therefore, the user will not get hurt.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a seat back reclining member according to the present invention;

FIG. 2 is a top plan view of an embodiment according to the present invention;

FIG. 3 is an explosive view of an embodiment of a reclining member according to the present invention;

FIG. 4 is a cross sectional view of the reclining member according to the present invention;

FIG. 5 is an explosive view of a stopping member according to the present invention;

FIG. 6 is a cross sectional view of the stopping member according to the present invention;

FIG. 7 is a partial view showing movement of the reclining member according to the present invention;

FIG. 8 is a partial view showing movement of the reclining member according to the present invention;

FIG. 9 shows operation of an operation rod according to the present invention;

FIG. 10 shows operation of a stopping member according to the present invention.

### DETAILED DESCRIPTION OF THE PREFERRED EMBODIMENT

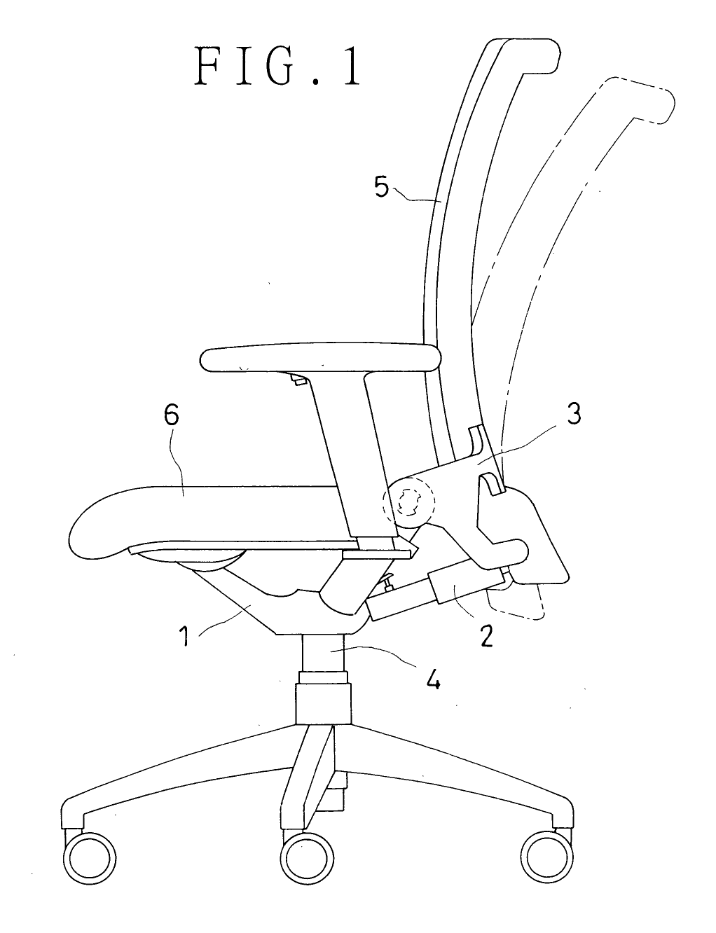

Refer to FIG. 1, a seat back reclining member according to the present invention includes a seat bracket (1), a reclining member (2) assembled and connected with a center of the seat bracket (1), and a stopping member (3) connected on two sides of the seat bracket (1).

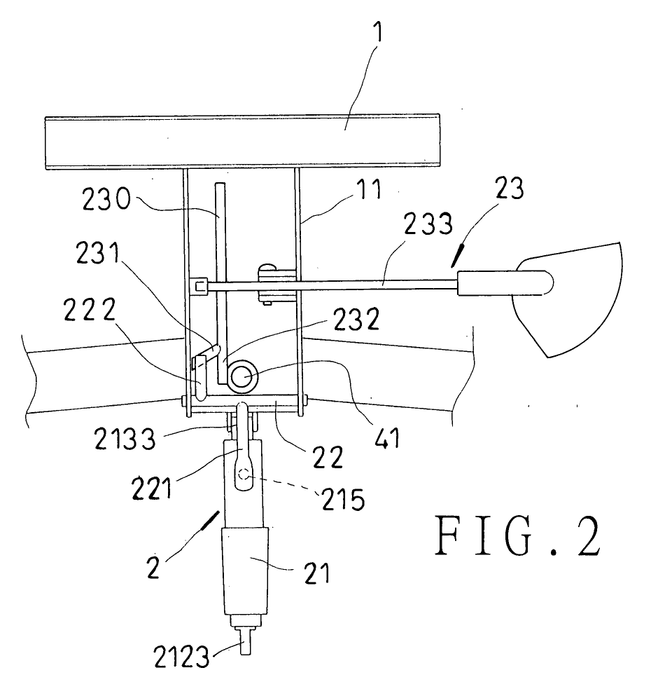

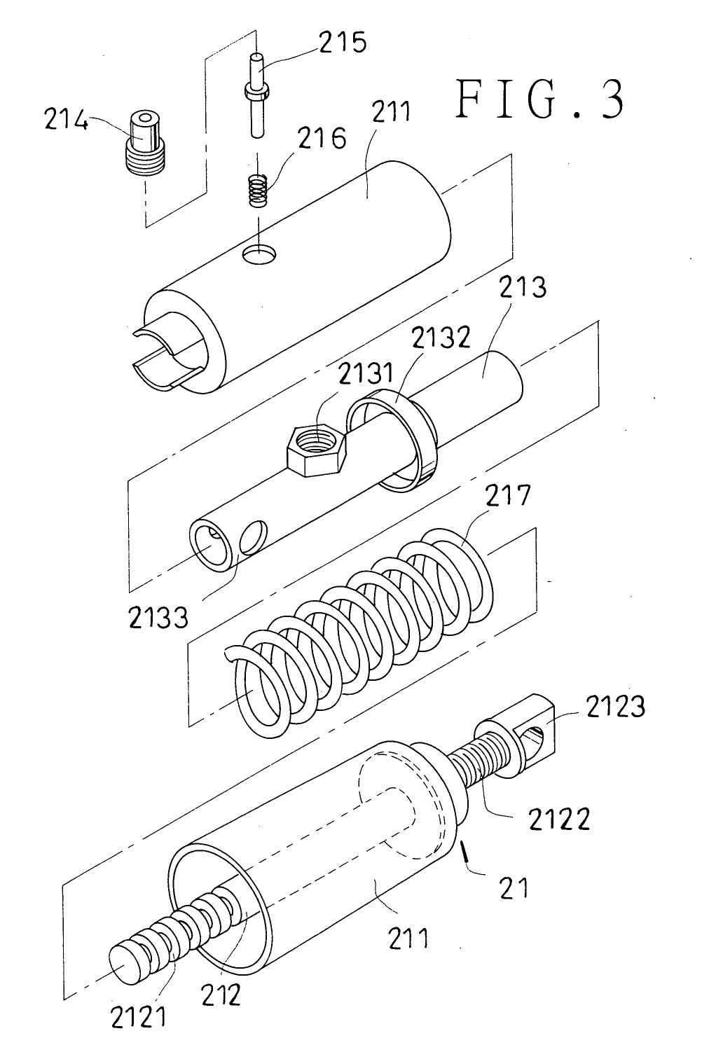

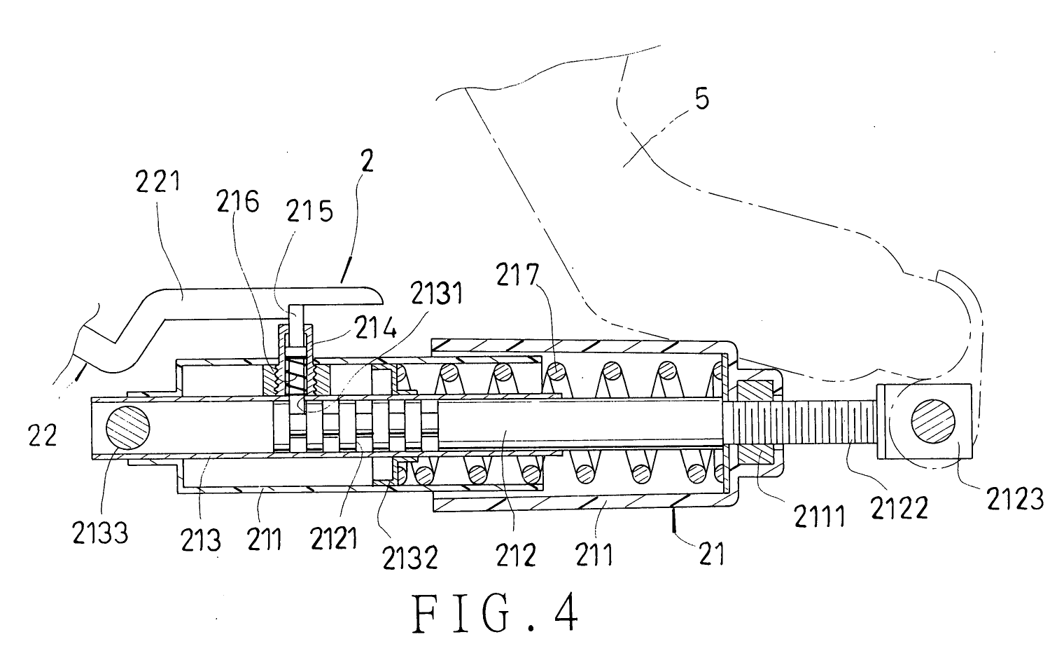

Also refer to FIG. 2, the reclining member (2) consists of an adjustment unit (21), a brake lever (22) and an operation rod (23). Also refer to FIG. 3 & FIG. 4, the adjustment unit (21) is disposed with two sleeved sleeves (211). An adjustment rod (212) with a plurality of locking slots (2121) thereon is arranged in the sleeves (211). Moreover, one end of the adjustment rod (212) is an outer threaded section (2122) that is assembled with a threaded member (2111) connected on one end of the sleeve (211). A fixed connection part (2123) that connects with a seat back (5) is formed on one end of the adjustment rod (212). Furthermore, an elastic member (217) is mounted in the sleeve (211). One end of the elastic member (217) leans against the bottom of the sleeve (211) while the other end of the elastic member (217) is against and contacted with a blocking ring (2132) around a shaft sleeve (213) and the adjustment rod (212) therein. An insertion hole (2131) is located on the shaft sleeve (213) while a pin bush (214) is arranged above and connected with the insertion hole (2131) on the shaft sleeve (213). A locating pin (215) and a corresponding elastic member (216) leaning against the locating pin (215) are mounted in the pin bush (214). The bottom end of the locating pin (215) inserts into the insertion hole (2131) of the shaft sleeve (213) so as to lean against the locking slot (2121) of the adjustment rod (212). As to the top end of the locating pin (215), it projects out of the pin bush (214). In addition, a top end of the shaft sleeve (213) is a fixed connection part (2133) that is assembled and connected with the seat bracket (1).

The brake lever (22) is pivoted on an assembling disc (11) of the seat bracket (1) while a pressing block (221) extending from one end of the brake lever (22) presses and brakes on the locating pin (215) outside the pin bush (214). A stopper (222) extends from the other end of the brake lever (22).

The operation rod (23) includes a main rod (230) in the assembling disc (11) of the seat bracket (1), a stopping block (231) connected with the main rod (230) and corresponding to the bottom of the stopper (222), a releasing block (232) extending from the main rod (230) and corresponding to a lifting button (41) of a lifting device (4) on the bottom of the seat bracket (1), and a grip (233) extending from the main rod (230) and penetrating the assembling disc (11).

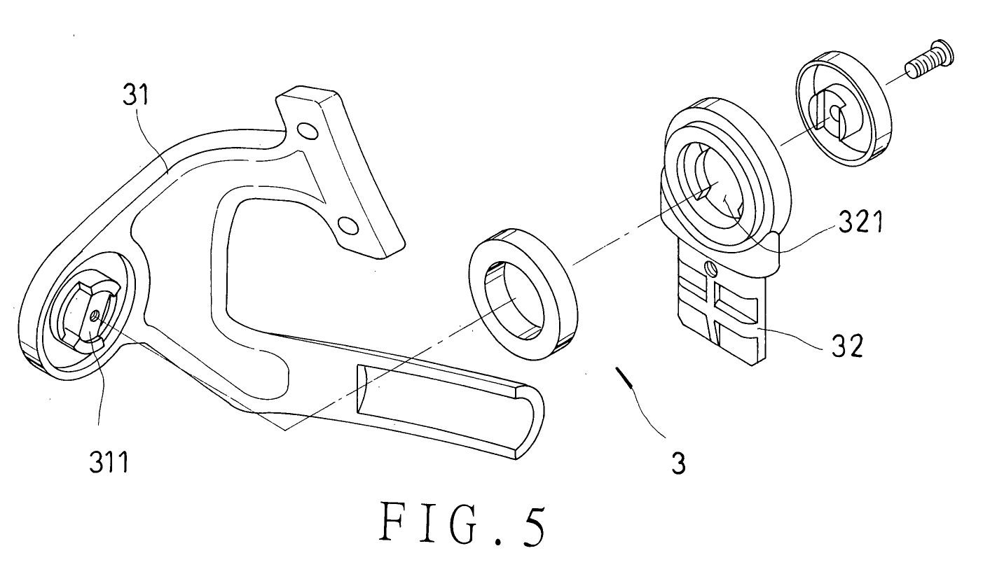

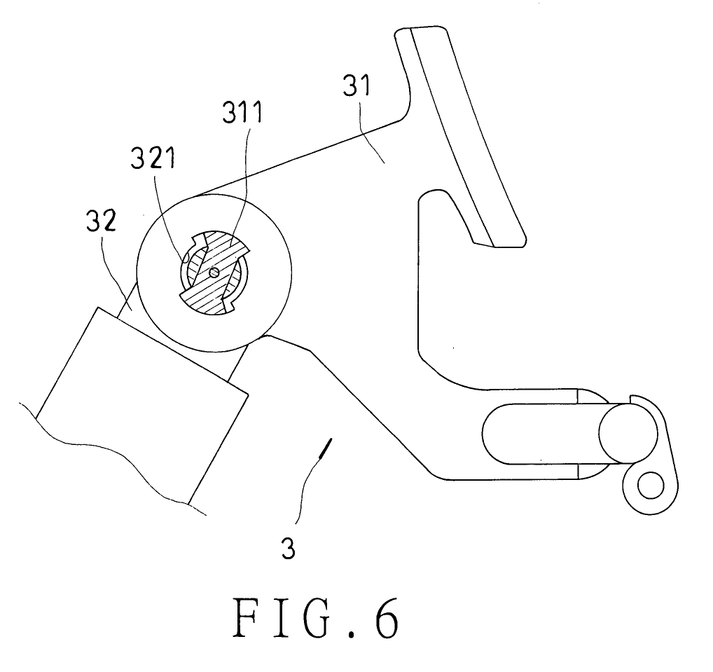

Refer from FIG. 5 & FIG. 6, the stopping member (3) is composed of a primary part (31) connected with the chair seat back (5) and a secondary part (32) connected and assembled with the seat bracket (1). A stop block (311) is formed on the primary part (31) and a stop slot (321) is mounted on the secondary part (32). The stop block (311) pivots on the stop slot (321) correspondingly and there is an allowance between the stop slot (321) and the stop block (311) so as to make the primary part (31) and the secondary part (32) rotate toward each other to a certain degree.

Thereby while assembling all the components, back to FIG. 1, a seat (6) is assembled over the seat bracket (1). And the seat back (5) is assembled and connected with the primary part (31) of the stopping member (3). Moreover, the secondary part (32) of the stopping member (3) is fixed and disposed on the seat bracket (1). Then the fixed connection part (2133) on one end of the shaft sleeve (213) of the adjustment unit (21) of the reclining member (2) is fixed on and assembled with the seat bracket (1). Furthermore, the fixed connection part (2123) on the end of the adjustment rod (212) of the adjustment unit (21) is assembled with the seat back (5).

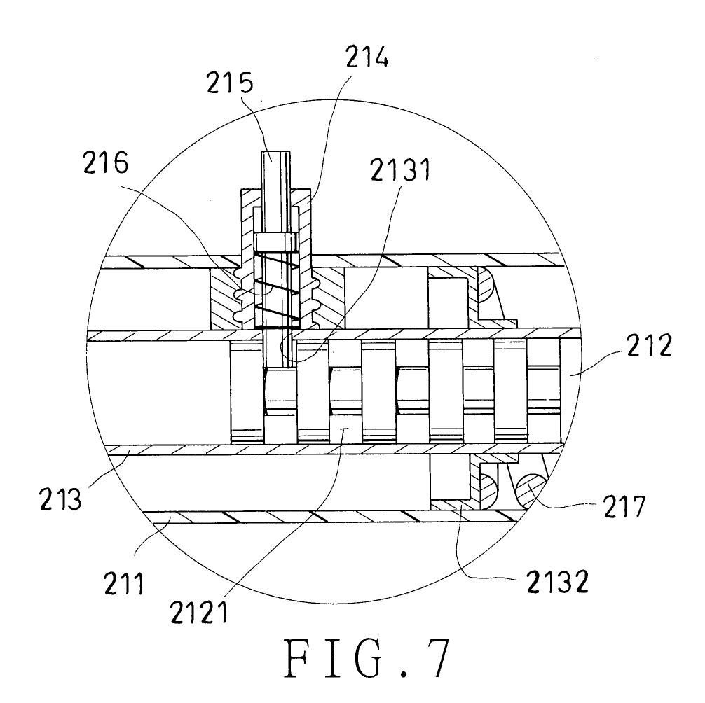

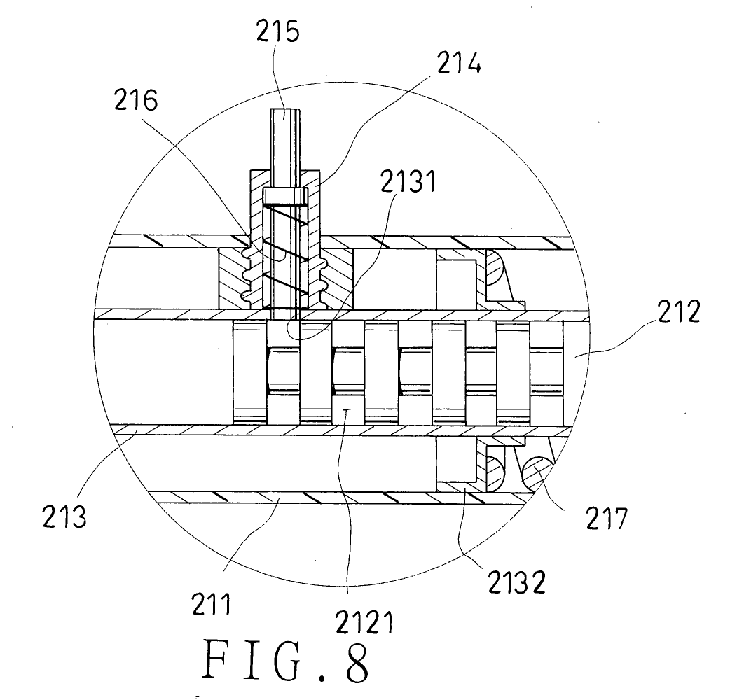

Thereby when users intend to adjust reclining angles of the seat back (5) for finding more comfortable position, they apply a back force to the seat back (5) so as to make the adjustment rod (212) of the reclining member (2) assemble and connect with the seat back (5) move. Now the locating pin (215) originally locked and pressed on the locking slot (2121) of the adjustment rod (212) also shifts to be released due to movement of the adjustment rod (212), as shown in FIG. 7 & FIG. 8.

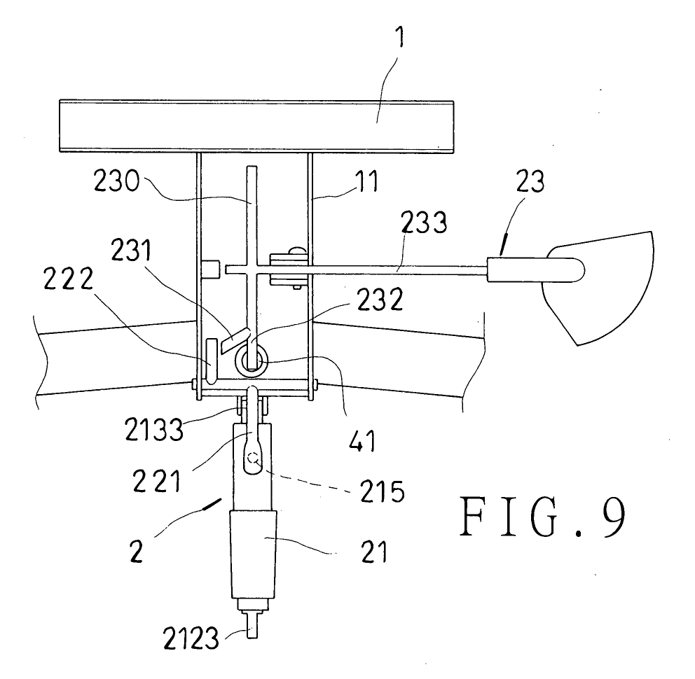

At the same time, refer to FIG. 9, the user's hand holds the grip (233) of the operation rod (23) and applies certain force to the operation rod (23) for being pulled outwards. Then the stopping block (231) stopped on the bottom of the stopper (222) of the brake lever (22) is released so that the brake lever (22) is moveable. Thus the locating pin (215) is pressed and braked by the pressing block (221) of the brake lever (22) is also released. And then the locating pin (215) is pushed and supported by the elastic member (216) against thereof so that the bottom of the locating pin (215) is out of and is released from the locking slot (2121) of the adjustment rod (212).

After the locating pin (215) being released, the adjustment rod (212) assembled and connected with the seat back (5) is moveable now. Thus the reclining angle of the seat back (5) is adjustable. After the seat back (5) being adjusted to the required angle, the operation rod (23) is pushed inward so that the stopping block (231) of the operation rod (23) again is stopped and brake on the bottom of the stopper (222) of the brake lever (22). And now the pressing block (221) on the other end of the brake lever (22) presses the locating pin (215) downward so that the locating pin (215) is pressed into the locking slot (2121) of the adjustment rod (212). Simultaneously, the user is not leaning against the seat back (5) so that the pulling between the seat back (5) and the adjustment rod (212) assembled and connected with the seat back (5) is further released. Then the adjustment rod (212) connected with the sleeve (211) is pushed by the elastic member (217) of the sleeve (211) so that the adjustment rod (212) and the locating pin (215) inserting into the locking slot (2121) thereof press and lock each other firmly. Therefore, the adjustment and locating of reclining angle of the seat back (5) is finished.

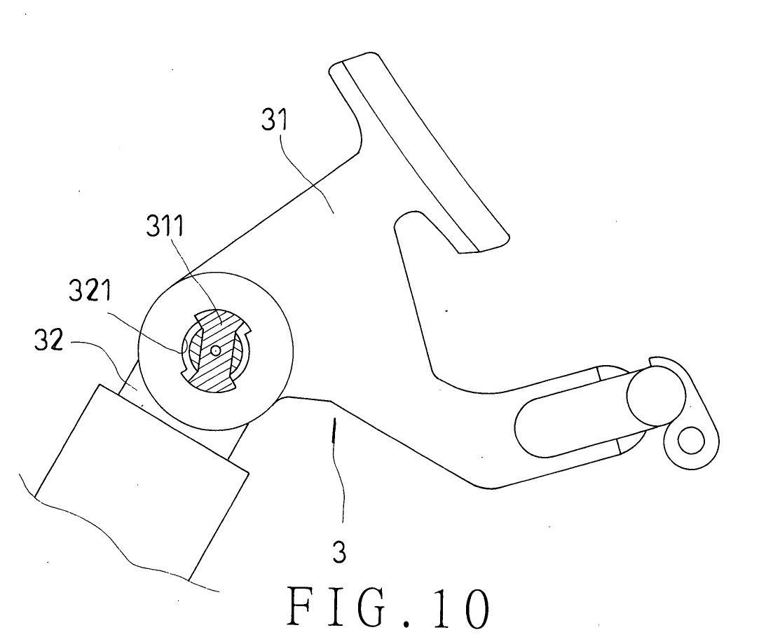

By the locking and locating between the locating pin (215) and the locking slot (2121) of the adjustment rod (212), the reclining angle of the seat back (5) after adjustment is fixed so that the users feel stable and comfortable while reclining back in the seat back (5). In addition, refer to FIG. 10, by the stopping member (3) disposed on two sides of the seat bracket (1) and the seat back (5), the safety of the users is further improved while sitting on the seat. Even the locating pin (215) and the locking slot (2121) of the adjustment rod (212) are not locked with each other firmly or the elastic member (217) has become elastic fatigue or broken when the chair has been used for quite a long period of time, the stopping member (3) supports the seat back (5) and keeps the seat back (5) reclining to a certain angle. Thus the user will not get hurt due to no support of the seat back (5).

Back to FIG. 9, when the operation rod (23) is pulled outwards so as to make the stopping block (231) and the stopper (222) of the brake lever (22) displace relative to each other. While releasing the locating of the brake lever (22), the releasing block (232) of the operation rod (23) just moves above the a lifting button (41) of the lifting device (4) that projects out of the assembling disc (11) of the seat bracket (1). Now the user can rotate the operation rod (23) so as to make the releasing block (232) press and brake the lifting button (41) for driving the lifting device (4). Thus the height of the seat is also adjusted while adjusting the reclining angle of the seat back (5).

Thereby the seat back reclining member of the present invention has the following advantages:
1. By the locking slot on the adjustment rod and the locating pin locking each other, the reclining angle of the seat back is adjusted by the seat back reclining member and is located stably after adjustment. Thereby, people leaning on the chair have comfortable and stable feelings.
2. The stopping members are disposed on two sides of the seat bracket and the seat back. Thus the seat back still has certain support even the locating pin and the locking slot of the adjustment rod are not locked with each other firmly or the elastic member has become elastic fatigue or broken. The injuries of people caused by above conditions can be avoided.
3. While adjusting the reclining angle of the seat back, the height of the seat can also be adjusted. Thus the adjustment of the chair is more simple and convenient.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A seat back reclining member assembled with a seat bracket comprising:
a reclining member having an adjustment unit, a brake lever and an operation rod; wherein the adjustment unit is disposed with a sleeved sleeve and an adjustment rod with a plurality of locking slots is mounted in the sleeve; one end of the adjustment rod is an outer threaded section that is assembled with a threaded member connected on one end of the sleeve; a fixed connection part that connects with a seat back is formed on an end of the adjustment rod; an elastic member is also arranged in the sleeve and one end of the elastic member leans against the bottom of the sleeve while the other end of the elastic member is against and contacted with a blocking ring fixed around the shaft sleeve that encloses the adjustment rod; an insertion hole is formed on the shaft sleeve while a pine bush is arranged above and connected with the insertion hole; a locating pin and a corresponding elastic member leaning against the locating pin are mounted in the pin bush and the bottom end of the locating pin inserts into the insertion hole of the shaft sleeve so as to lean against the locking slot of the adjustment rod while the top end of the locating pin projects out of the pin bush; a fixed connection part is formed on one end of the shaft sleeve so as to be assembled and connected with the seat bracket;
the brake lever is pivoted on an assembling disc of the seat bracket while a pressing block extending from one side of the brake lever presses and brakes on the locating pin projecting out of the pin bush, and an stopper extends from the other side of the brake lever;
the operation rod having a main rod arranged in the assembling disc of the seat bracket, a stopping block connected with the main rod and corresponding to the bottom of the stopper of the brake lever, and a grip penetrating the assembling disc and extending from the main rod.

2. The device as claimed in claim 1, wherein the seat back reclining member further includes stopping members disposed on two sides of the seat bracket respectively; the stopping member having a primary part that is connected with the seat back and having a stop block, and a secondary part that is connected and assembled with the seat bracket and having a stop slot; the stop slot of the secondary part pivots and connects with the stop block of the primary part correspondingly and there is an allowance between the stop slot and the stop block.

3. The device as claimed in claim 1, wherein a lifting device is disposed on the bottom of the seat bracket and the lifting device includes a lifting button that projects out of the assembling disc while a releasing block is extended from the main rod of the operation rod that presses and brakes the lifting button correspondingly.
